(19) United States
(12) Patent Application Publication
(10) Pub. No.: US 2011/0179119 A1
(43) Pub. Date: Jul. 21, 2011

(54) International data memorial.com ("IDM")

(76) Inventor: William Bryan Penn, Memphis, TN (US)

(21) Appl. No.: 12/930,527

(22) Filed: Jan. 10, 2011

Related U.S. Application Data
(60) Provisional application No. 61/293,301, filed on Jan. 8, 2010.

(51) Int. Cl. G06F 15/16

(52) U.S. Cl. 709/205; 709/219; 709/206

(57) ABSTRACT

A general interest website marketed to achieve a business objective as the “IDM everyday . . . the website for your life.” IDM provides a self-authenticating, chronological, archiving process and cloud server featuring permanent uploads to file documents in private or public files, a social/business network, email and forum. IDM's permanent features are a service not otherwise available on the Internet. A user of IDM may (1) socialize with friends, relatives or businesses, (2) view or upload documents or photographs, (3) download templates, (4) purchase legal documents filled out pursuant to the users' specific instructions, (5) submit questions to our bank of life experts, (6) create a private profile and journal, (7) blog on the forums, (8) comment on uploads, (9) rate uploads, (10) email, (11) invite friends to view/comment/rate uploads, (12) permanently record information, (13) network with others, (14) visit our physical locations, and (15) use the IDM APP to “link” to IDM from smart phones and any private computer or laptop. All uploads, forums, blogs, and files are stored onto IDM as permanent files, stored in the chronological order it was received or made.

### SUMMARY OF THE INVENTION

The present invention relates to methods and systems for permanently preserving documents, photographs, collections, records, legacies, thoughts, journals, and conversations. The present invention uses an Internet website to create a process and a location by which someone, a customer (which we will refer to herein as the user) may have a permanent place to store these items without the difficulties in having to search endless paper work, files, boxes or other file storage services for their important documents, photographs, collections, records, legacies, thoughts, journals, and conversations. The present invention also contemplates the use of the Internet to streamline the processes, and to create a location which will permit these permanently stored materials to be chronologically stored on the website. These materials may also be archived in various public or private files for quick reference and retrieval by the users. Additionally, these materials will be permanently stored on IDM in a manner that will comply with the federal Rules of Evidence, and therefore, the rules of most states, so that those materials may be self-authenticated and used as evidence in judicial or legal proceedings. Finally, a user may use IDM as a cloud server to access their materials on any smart phone, lap top or personal computer without having to access their own computer server.

Disclosed herein is Internet method or process for a user to fully utilize this website from a computerized instrument such as an personal computer, smart phone, lap top or notebook computer. Computerized access could also use the IDM web site as a cloud server so that the user does not have to use a server, but may store and access all necessary documents, photographs or other services simply by contacting IDM.

The effort of our website will be to emphasize to the user the need to have easy access to permanent, self-authenticated, chronological, archived uploads. IDM will stress our message to secure the user's past and future. Most people have no idea what happened to all of their important information and favorite photos from five years ago, but anyone can know five years from now.

Don't let history pass you by! Use IDM Everyday!

This website is being marketed as the “IDM everyday . . . the website for your life.” A user or visitor to our website (1) may view the postings from around the globe that have been uploaded on the public website displays made available under the various topical screens, (2) may upload up to a specified limit at no cost that person's own documents or photographs onto either a public file (observable by the public) or private file (observable to only the person who uploaded the document and those provided the pass-code for the private file), (3) may download any of the various documents available on the site that are templates, (4) may download any of the various forms available on the site that are templates and legal documents filled out and printed pursuant to the users specific instructions, (5) may submit questions or read the bank of opinions to our panel of experts from different professions or backgrounds and parts of the globe for the experts to post their opinions to the questions asked in either a public or private file, (6) may upload works for the purpose of keeping the document, statement, memento, opinion, work, photograph, file or art recorded in time as a secondary file or manner in which the original is backed up in a self-authenticated and permanently stored record, (7) may participate on the blog discussion available on the site, (8) may comment on a document, statement, memento, opinion, work, photograph, file or art recorded publically on the forum (9) may rate the document or photo by indicating a preference out of a five star ranking, (10) may email the owner of the document, (11) may invite his friends to view/comment/rate his upload, (12) use the site as a permanent record of their social networking, (13) take advantage of the services and advertisers as promoted by the website, and (14) use this website as a social networking website where the user's information may be personally controlled by the user and stored either publically or privately in a chronological file.

Of course, (15) everyone is welcome to visit either of our IDM facilities, which as the only year-round art fair available in the United States, display and sell art, antiques and fashion aspects of IDM or you may visit the IDM stations also on display or visit the websites linked to IDM.

Finally, (16) we will make health and life insurance policies available to IDM users as IDM strives to meet the daily needs of its customers.

IDM is the first of its kind and (17) the only Universal Personal Permanent Cloud Server. The free services and technology is also a distinct advantage for IDM. There are various other websites that provide similar or partial services, however, there are no websites that contain each and every aspect of IDM. Individually, the websites do not even compete with IDM on the single service they provide. Only IDM has the archiving, self-authenticating aspects that memorialize the uploaded documents on our website. Our IDM experts have business locations from coast to coast and internationally; and, we have contacts around the world. For example, our art expert has contacts at various businesses and hotels; our other experts have contacts globally and are willing to work with us in a partnership to be a part of IDM. Another example is that once our forms are used and downloaded, they can be executed and then uploaded on IDM to be kept in a personal, private, permanent file.

IDM is a natural advertising and business partner, as our high-end guests will appreciate our high-end offerings for the arts, antiques and life experts, our free social features will document and archive the communications between our users about their uploaded documents, forms, photos or forum discussions. All users, whether an artist, serious collector, investor or private person will have a market place to display and chronologically archive their works, files, photos or documents.

These features may be used, or not, as desired for any particular user. Other embodiments and advantages of the invention are set forth in part in the description which follows, and in part, will be obvious from this description, or may be learned from the practice using the invention.

### DESCRIPTION OF THE DRAWINGS/ILLUSTRATIONS

FIG. 1: depicts the International Data Memorial.com home page and assembled as the website appears in its current form, with the UPLOAD Browser Bar Displayed.

FIG. 2: depicts one screen shot of the International Data Memorial.com home page for the IDM Forum as the website appears in its current form with identifying details.

FIG. 3: illustrates a schematic of several embodiments of the various configurations of the invention when compared to the other Internet Competitors.

### DESCRIPTION OF THE INVENTION

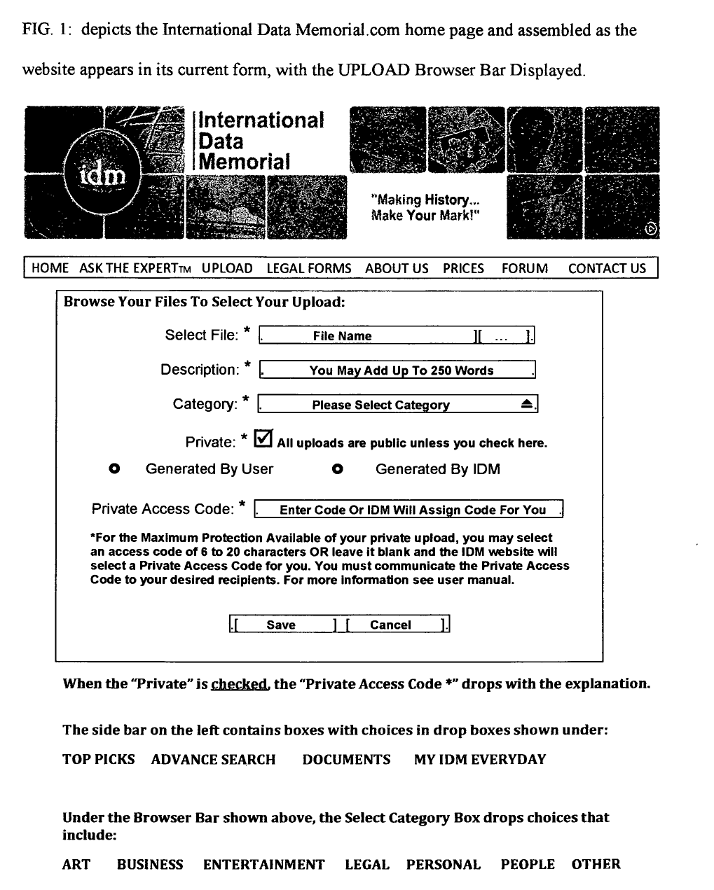

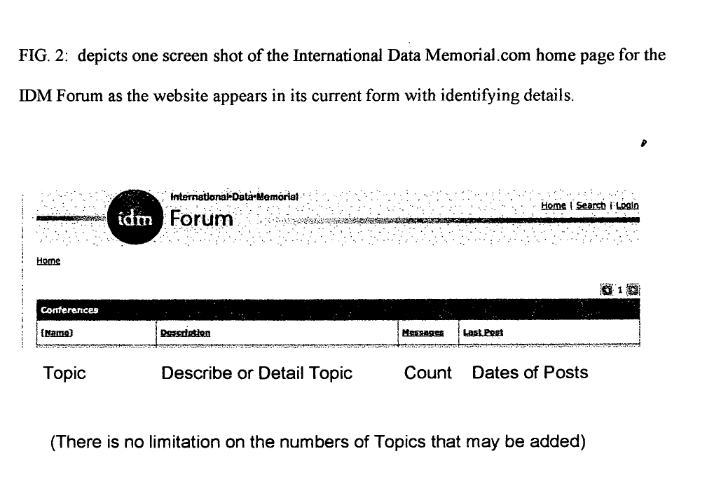

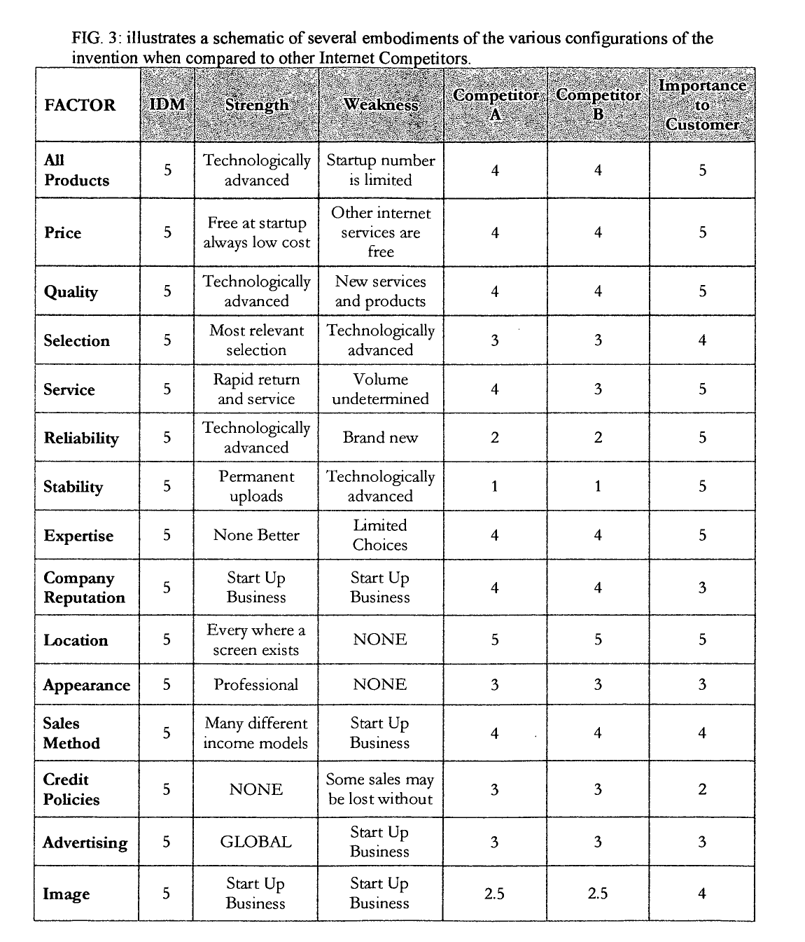

1. Permanent uploads on the Internet are not believed to exist. The closest any website has come to permanence is Twitter, which reports that its users now broadcast about 55 million tweets a day, so that in just four years about 10 billion of these messages have accumulated. So Twitter recently announced its plans to donate its archives to the Library of Congress and to supply continuous updates. In this way, Twitter does not keep any uploads (known as “tweets”), nor do they self-authenticate, archive or act as a cloud server.
2. One skilled in the art of Internet usage or the law will understand that there are no self-authenticating sources on the Internet. Likewise, chronological uploads and archiving services may be provided in the sort term, however, there are no sites on the Internet for storage and future reference of permanent public or private files, documents and uploads. There are back up websites and cloud server websites, but all of the information on those websites are not permanent, self-authenticating, chronological archives.
3. The present invention uses a process to permit uploads to the IDM website to be a permanent fixture. The permanent Internet uploads may include any form of any item or volume of a document, photograph, video or file transmission, including but not limited to .txt, docx., doc., pdf., jpg. .xls, xlsx, .inf, .htm, .html, .wpd, .bmp, rtf, .lnk, .inf, .eml, .wbk. This is not an exhaustive list of the types of files that may be transmitted over the Internet to IDM website(s) or forum(s) or blog(s). As a preferred embodiment, once uploaded, these forms will not be able to be manipulated or altered.
4. As a preferred embodiment, once the user submits the upload to the website, the upload cannot be altered, it may be suppressed into a private file not available for public viewing for any limited number of reasons such as violation of any law, copyright infringement, direction of the user or discretion of the IDM administrator. The user may select the upload to be a public or private upload at the time the upload is put onto the website. A product reference may include any type of file, including, but not limited to, pdf, eps, tiff, jpeg, gif, png, mpeg, mp3, mp4, avi, and mov.
5. As a preferred embodiment a user may view any of the categories of permanent public uploads displayed on the website. While viewing uploads, a user may select the icon on the upload to enlarge the picture, which will display the permanent watermark every permanent upload is given on the website. This watermark provides for IDM authentication and copyright designation as a preferred embodiment.
6. As a preferred embodiment a user may view any of the categories of permanent public uploads displayed on the website. While viewing uploads, a user may select the icon on the upload to view the permanent, public upload's “file information”, “author name” and “description.”
7. As a preferred embodiment, a user may view any of the categories of permanent public uploads displayed on the website. While viewing uploads, a user may select the icon on the upload to “comment” on the upload, which posts the comments on the permanent, public upload.
8. Refer to FIG. 1: depicting two screen shots of the International Data Memorial.com home page and assembled as the website appears in its current form. A user may send a permanent upload into the user's public or private files as the user chooses, but the upload will be stored into one of the various files, including but not exclusively the user's “People”, “Business”, “Art”, or “Entertainment” file. As a preferred embodiment, anyone may visit the website simply to view any publicly posted documents, files, photographs or other type of uploads. There is no cost or restriction for someone to engage in this type of review.
9. Refer to FIG. 2: depicting one screen shot of the International Data Memorial.com home page for the IDM Forum as the website appears in its current form. Anyone may also view the forums or blogs also posted on the website. As another preferred embodiment, anyone may search for any sort of individual or topic that has any upload or file on the website.
10. As a preferred embodiment, anyone may create a file or join the forum/blog or upload by registering on the website, using their email address and password of their choice to create a login code and password. The website will forward to that user, the access code to the website to verify the email address of the user. Thereafter, every time that user wants to login to IDM, that user may simply chose the “Login” icon and enter their previous posted email address and password to have the full access to the website. As a preferred embodiment, the password is case sensitive.
11. As a preferred embodiment, once logged onto the website, a user may take advantage of any of the various services of the website. This log on will also be a part of the protection of the website as it will provide a means to control who will be accessing the website. This log on will also permit the website to track the usage and the user activity on the website. As a preferred embodiment, once the log on has occurred, the activity may be tracked of that user. This information may be used to modify aspects of the website in the future or direct advertising for website promotions.
12. As a preferred embodiment, a user may log onto the website and upload any number of documents in either a public or private file as that user dictates during the upload process. This process begins by selecting the “upload” icon on the home page of the website, after the user has created a log on and entered a valid password. As an additional embodiment, should the user forget the password or email address, the website will forward another email to the user's log on address to permit the user to identify another password, refresh and remind the user of the current password and to permit the user to access the website functions. The user may choose to cancel the login process or may proceed to enter the site. To log off of the site, the user needs to close the search engine on the user's computer and this will end the session of the user's access to the website.
13. As a preferred embodiment, once the user has pursued any various function of the website, the user may chose to return to the homepage by selecting the “home” icon. Selecting the “home” icon will return the website to the base home page.
14. As a preferred embodiment, once the user is logged in, the user may access and direct any number of questions to the experts as shown on the drop bar on the home page. Any expert chosen by the user may respond to the user's question(s) as the expert deems appropriate or necessary. The response to the user's question may be posted by the user or the expert in a public or private file on the website. The expert and the website administrator has the final determination on whether or not a response is to be suppressed to a private file.
15. As a preferred embodiment, the user may ask as many questions as the user wants. There will be a fee for asking the expert a question that is charged to the user that has to be paid at or before the time the question is asked. This payment process is another preferred embodiment. This payment goes to the website and is distributed as the website has previously arranged to do so with the experts.
16. As a preferred embodiment, once the payment and the question have been processed, the question(s) is directed to the IDM administrator and to the expert's email address or website as the IDM website has chosen with the expert's recommendation. Then, as a preferred embodiment, the answer is developed by the expert who then forwards the expert response to the website. As a preferred embodiment, once the expert response is received, the website posts the response on the website and transmits the expert response to the user who asked the question. As a preferred embodiment, this response is sent to the log in address as entered by the user during the log in for the question.
17. As a preferred embodiment, once the user logs in, the user may also select the “Legal Forms” icon to view any of the various legal forms, legal documents and templates as developed for the website. The user may then select any template or legal form from the dropdown toolbar as desired by the user. There is no limit to the choices and selections of either templates or legal forms that the user may utilize. There will be a fee for obtaining either the template or the legal form that is charged to the user that has to be paid at or before the time the form is chosen. This payment process is another preferred embodiment. This payment goes to the website and is distributed as the website has previously arranged to do so.
18. As a preferred embodiment, once the user has chosen and paid for a template, the template is sent from the website to the user's log in email address. This is another preferred embodiment that the template is sent from the website directly to the user in a .pdf or similar format. This .pdf format may be altered, amended or substituted with any subsequent similar permanent and unalterable format method.
19. As a preferred embodiment, once the user has chosen a legal form, the user responds to the several questions and fills in the blanks related to that legal form. The user may review the legal form, and then make the payment for the cost of the legal form by sending payment for the legal form at the time the legal form is transmitted in it's final form from the website to the user's log in email address. This is another preferred embodiment that the legal form completed as the user directs is sent from the website directly to the user in a .pdf or similar format. This .pdf format may be altered, amended or substituted with any subsequent similar permanent and unalterable format method. As a preferred embodiment, the form received by the user will be unalterable in a .pdf or similar format. This form is also sent to the website, which saves a permanent copy of the form in a private file.
20. As a preferred embodiment, the email sending the completed legal form or template to the user will also provide that the user will be able to upload that form back to the website once it has been executed, signed and/or notarized. As a preferred embodiment, to put this executed document back on the website, this legal form or template must be scanned and then transmitted to the website as are all other uploads sent to IDM after selecting the “Upload” icon and following the prompts and directions.
21. As a preferred embodiment, the forms chosen by the user contain a description and price of the form on the same icon that permits the user to “Fill Out” that selected form. If the user does not pay for that chosen form at the time the user fills out the form, the website does not keep the form and the user must resubmit the legal form, document or template if the user later decides to pay for that form. As a preferred embodiment, each legal document or form contains blanks to fill in and an “instruction for use” to help guide the user.
22. As a preferred embodiment, once the legal form has been filled in, the user may select either icon to “Preview”, “Save/Purchase” or “Cancel” the chosen form. If the “Preview” icon is chosen, once viewed the previewed document may be then saved/purchased or cancelled after selecting the designated icon to “Save/Purchase” or “Cancel” the form. The previewed form may be simply reduced back to the original document where any adjustment may be made to the form before it is finalized. As a preferred embodiment, once the form is finalized by purchasing the form, it will be permanent and not be able to be altered. The user will have to select another form or pay for a second form if any change is desired after the form has been finalized.
23. As a preferred embodiment, the user may select the “Forum” icon from the drop bar and the user will be transferred to the International Data Memorial Forum. On this forum, a user may review the conferences, view the descriptions of the various topics available to discuss, and even review the threads or messages as posted by other users. There is no requirement to login to review these threads and postings, however, as a preferred embodiment, the user must login to actually post any of the user's desired threads, comments or replies.
24. As a preferred embodiment, the user must login or register to actually post any of the user's desired threads, comments or replies to the IDM Forum. After logging in, the user may post any of the user's own threads, comments or replies. All of these threads, comments and/or replies will become permanent on the website as a preferred embodiment.
25. As a preferred embodiment, a user who has logged in on IDM and chosen to transfer to the IDM Forum must log in or register on the IDM Forum. This is an additional method to record the identity of the user and to control the information posted permanently on the website. The IDM Forum is a method to permanently record the blogging of any user who utilizes these services.
26. As a preferred embodiment, any user of the IDM Forum must also log in or register and log in to be able to view the user's own profile or search for any “search terms” that the user seeks. On the “Search” icon, the user may search terms and select a match for any phrase or words used on the IDM Forum.
27. As a preferred embodiment, once the user has completed use of the IDM Forum the page can be closed out, but if the user has logged on, then the user must Logout by pressing the “Logout” icon or close out the server window in order to terminate the session on the IDM Forum.
28. As a preferred embodiment, a user may access the side drop bar that will provide for the user to view the permanent, public uploads with the top “Rating by Users”, “Viewed by Users”, “Commented On”, “Uploader”, and/or “Administrator Pick”. The user may select any of the displayed uploads to be enlarged, choose the icon to email to the author, or score the upload by selecting one of the five stars to rank the upload.
29. As a preferred embodiment, a user may access the side drop bar that will provide for the user to view the “Advance Search” to identify uploads by a “keyword” a “First Name” and/or “Last Name” under a category and/or a time range that the user seeks to identify the upload(s).
30. As a preferred embodiment, a user may access the side drop bar that will provide for the user to view all permanent, public “DOCUMENTS” not to be exclusively including images, PDFs or Plain Text documents. The user may also view any public upload within the provided time frame.
31. As a preferred embodiment, a user may access the side drop bar that will provide for the user to view that user's own “Profile”, “Documents”, “Contacts” or “Communications” that the user has on IDM.
32. As a preferred embodiment, the IDM administrator may view the user public information or uploads, and the user access to the website may also be monitored or restricted, as well as the IDM administrator may re-designate an upload from public to private. The IDM administrator will also provide for certification of uploads that will be provided from the website as necessary to establish compliance with the self-authentication aspect of the website. The IDM administrator will also comply with any and all court orders for access to website uploads whether public or private for any subpoenaed upload or access to any estate for a deceased user pursuant to the law.
33. As a preferred embodiment, IDM will use the aspect of the permanent upload with an IDM watermark to provide self-authenticated copies of the uploads on the website pursuant to the user's request or the legal requirements as the case may be. Establishing the self-authenticated forms will require complying with the Federal Rules of Evidence (2010) (incorporating revisions that took effect Dec. 1, 2010) providing (italicized in relevant part):
Rule 803. Hearsay Exceptions; Availability of Declarant Immaterial The following are not excluded by the hearsay rule, even though the declarant is available as a witness:
(6) Records of regularly conducted activity. A memorandum, report, record, or data compilation, in any form, of acts, events, conditions, opinions, or diagnoses, made at or near the time by, or from information transmitted by, a person with knowledge, if kept in the course of a regularly conducted business activity, and if it was the regular practice of that business activity to make the memorandum, report, record or data compilation, all as shown by the testimony of the custodian or other qualified witness, or by certification that complies with Rule 902(11), Rule 902(12), or a statute permitting certification, unless the source of information or the method or circumstances of preparation indicate lack of trustworthiness. The term “business” as used in this paragraph includes business, institution, association, profession, occupation, and calling of every kind, whether or not conducted for profit.
Rule 902. Self-authentication
Extrinsic evidence of authenticity as a condition precedent to admissibility is not required with respect to the following:
(11) Certified domestic records of regularly conducted activity. The original or a duplicate of a domestic record of regularly conducted activity that would be admissible under Rule 803(6) if accompanied by a written declaration of its custodian or other qualified person, in a manner complying with any Act of Congress or rule prescribed by the Supreme Court pursuant to statutory authority, certifying that the record:
(A) was made at or near the time of the occurrence of the matters set forth by, or from information transmitted by, a person with knowledge of those matters;
(B) was kept in the course of the regularly conducted activity; and
(C) was made by the regularly conducted activity as a regular practice. A party intending to offer a record into evidence under this paragraph must provide written notice of that intention to all adverse parties, and must make the record and declaration available for inspection sufficiently in advance of their offer into evidence to provide an adverse party with a fair opportunity to challenge them.
(12) Certified foreign records of regularly conducted activity. In a civil case, the original or a duplicate of a foreign record of regularly conducted activity that would be admissible under Rule 803(6) if accompanied by a written declaration by its custodian or other qualified person certifying that the record:
(A) was made at or near the time of the occurrence of the matters set forth by, or from information transmitted by, a person with knowledge of those matters;
(B) was kept in the course of the regularly conducted activity; and
(C) was made by the regularly conducted activity as a regular practice. The declaration must be signed in a manner that, if falsely made, would subject the maker to criminal penalty under the laws of the country where the declaration is signed. A party intending to offer a record into evidence under this paragraph must provide written notice of that intention to all adverse parties, and must make the record and declaration available for inspection sufficiently in advance of their offer into evidence to provide an adverse party with a fair opportunity to challenge them.
   34. A technical advantage of the present invention is that it may be used to significantly reduce the amount of time involved in preparing for trials, reviewing collections, finding archives, observing chronologies or accessing a cloud server. The amount of time reduction is surprising. As a result of the time reductions realized, materials can often be obtained weeks in advance-instead of months or never (which was previously the norm for some users). In some cases, materials can be retrieved in a matter of minutes (and possibly seconds in the cases of one page uploads).
   35. Another technical advantage of the present invention is that it may be used to significantly reduce the cost involved in preparing for litigation, sales and archiving collections. The cost savings is surprising.
   36. Another technical advantage of the present invention is that the method and systems permit a user to create high quality chronologies, journals and archive materials without the services of a lawyer or other professional service, thereby realizing unexpected savings in time and expense.
   37. The present invention is also directed to a software program developed to significantly reduce the time and frustration associated with current methods of developing a record, archives, journals and evidence. As an embodiment to this invention, an IDM App will permit an Internet user to access IDM through the click of an icon, to select a template, a number of pages, and other information, and to point and click through a systematic method of circular development. Upon login, the user is preferably presented with updates and messages about new uploads, emails, sales or new additions to the program.
   38. Upon receipt of the payment, the user may generate a preview (e.g. user's proof or electronic preview), which preview may be transmitted to the user (by way of facsimile, electronic mail, website, wireless technology) if approved or modified if additional modifications are desired in the legal document.
   39. The present invention requires a computer or computing access device to view the website. Preferably, the computer includes a modem (e.g. dial-up connections such 14.4, 28.8 or 56K modem, DSL, cable), more preferably high speed, or other access interface (e.g. a T1 or T3 connection, wireless, Bluetooth, satellite) to permit high speed access to a server or to the IDM server. Preferably, the computer includes software to permit rapid and reliable access to the user so that the uploads are more rapidly made to the website.
   40. Internet, preferably the user has an account with an Internet access provider. In setting up an Internet connection, it may be desirable to utilize cache to keep local copies of frequently accessed pages, and thus reduce the demands on bandwidth to the network by the user.
   41. In one embodiment of the present invention, a user utilizes an Internet connection in order to access IDM on a host computer or else the user may have a smart phone or other device with no server. In that case, the user may utilize IDM as the server for the documents saved on the website. IDM, when accessed, may request a user to log into the site by entering a username and password. In the preferred embodiment, users will log in using a User Name and Password. However, in certain embodiments, additional information can be required, for example a subpoena or other court document related to a probate estate.
   42. Refer to FIG. 3: illustrates a schematic of several embodiments of the various configurations of the invention when compared to other Internet Competitors. Each of these competitors may provide for some similar degree of certain products, certain customers, or in certain locations similar products or similar methods, but no other website will directly compete with IDM as none of them provide permanent, self-authenticated, chronological archival services.
   43. For security, the User Name and Password can be an email address or combination of letters, numbers, and/or symbols. Preferably, each User Name is unique. Based on user identification, access to the system can be determined. For example, if the user is an administrator the system can provide the user access to administrator tools (described further herein). While if the user is not an administrator, the system can provide the user only access to the drop bar tools. In certain embodiments, user activities are tracked. In certain embodiments, user preferences are saved and accessed each time a user signs in. In certain embodiments, ads for which the current user is registered for are highlighted.
   44. Generally, a user will specify the upload file type that is desired. Preferably, the user selects a file type from a plurality of types as accepted on the computer screen. More preferably, the user selects from a pull down menu of file type that is desired. Examples include, but not limited, to .txt, docx., doc., pdf., jpg. .xls, xlsx.
   45. In certain embodiments, the system can create a grouped image. The grouped image is created by combining two or more uploads into a grouped image. The grouped image can be a single term, place, or named user and saved for future use.
   46. In certain embodiments, IDM logs errors and notifies an administrator or other support personnel. Notifications are triggered upon surpassing threshold levels. In certain embodiments, at least a portion of the processing is accomplished on the user's computer, but once uploaded on IDM it is permanent. In other embodiments, the entirety of the processing is accomplished on the IDM server. In certain embodiments there is an advance search which will group the requested search every time that search is requested.
   47. As an important embodiment, IDM provides for the user an Internet Universal Personal Permanent Cloud Server. This function permits IDM to act as a Cloud Server, Cloud Computer, Cloud Hosting and Online Storage. Cloud hosting has been broadly defined as an on-demand, pay-as-you-go, high-availability service, as opposed to an order-to-provision, annually-contracted, configure-your-own-backups and buy-or-lease-your-servers kind of a service.
   48. This present invention allows Users to purchase legal documents that can be downloaded, executed before a Notary Public (if necessary), then uploaded onto the IDM website for permanent, chronological archiving, either in a private or public file. Likewise, the form is stored onto the website when it is completed by the user for future access by the user. In a method to assist the user, the completed document is also transmitted to the user in a .pdf format for the user's execution and/or signature.
   49. In certain embodiments, a user is able to submit comments and new upload rankings. In certain embodiments, upon login, a user is presented with notices and/or tips to increase the traffic to his uploads by sending requests to his contacts for comments and rankings. The notices and tips are customizable by the administrator. The IDM forum provides a mechanism to connect users together to share best practices, ideas, advertisements, and content. Through user preferences, a user may elect to participate in the social network and may elect which information to share as well as what information is of interest to receive. A user may set a perimeter or buffer around an upload based on the user's desires to prevent sharing or receiving comments. The IDM Forum also provides a blog, chat, or other user forums for sharing ideas. This information may be shared with the system administrator to provide better products and services to users.
   50. IDM permanent data capturing and data warehouse functionality provides flexible and fast access. Users can construct and return reports at any time during use of IDM. Uploads may be exported as a common file data, for example as an Excel spreadsheet or a CSV file, for uploading to or collaborating with other business systems as the user may designate. Users may evaluate the effectiveness of their upload specific to their business needs quickly and efficiently. For example, business records can include, usage reports, specific product reports, margin reports, and request for commentary by the recipient as designated by the user.
   51. The IDM database can also be sorted by the demographic information to generate a target list for IDM advertisers.
   52. The IDM database may also be reviewed by the user at any time for other purposes, such as consolidation of information into the user's management system, backup, or online review. Use of authorized user names, passwords, and other security measures to control access to information stored on a computer database are well known and will be enforced.
   53. IDM will take advantage of the latest hardware technology to insure that its functions meet the market demand and expectations.
   54. Payment Method is used once the user designates a service for payment to IDM is created, approved, and submitted. It is an important subsequent step to obtain payment for the expense. It will be appreciated that payment does not occur until a request for payment is submitted to IDM. The present invention therefore includes a co-op calculation feature, which generates invoices upon demand, or as programmed. Payments can be received directly from a customer through a third-party credit card processing system, through a third-party bank withdrawal system, through cash, check, or other currency, or through another payment method.
   55. In the preferred embodiment, administrators have their own designated login in information. Administrators can have the ability to suppress or make an upload private individually. For example, if there is a copyright infringement or pornographic material in a public upload, it will be suppressed into a private file. Administrators also have the ability to manage information, logins, print specifications, and forum discussions. Such administrative tasks can be accessed from the main part of the application or through external avenues. In certain embodiments, the administrator can define or limit a user's access to the website.
   56. It is contemplated that the present invention may be implemented in a manner that provides an account for a user to access, and further that the account provides access to a memory storage device where the user may store data and other information relevant and/or unique to the user. For example, a host computer that may be accessed through an Internet connection may store upload references, templates, and other custom information for a user, such that when a user logs into its account, the information is readily available.
   57. In certain embodiments, the user can view themes (i.e. seasonal themes, holiday themes, color pallets) and, upon selection, apply the theme to a user's profile page layout. One selection controls all pages, one page, or combinations thereof.
   58. In one embodiment, the present invention will provide a one-to-one correspondence between the user and the administrator when a need arises due to error or other unforeseen difficulty.
   59. Besides the legal forms, once a template is chosen, the user is provided with an opportunity to customize the template after the user prints it out. In the case where a template involves multiple pages, the user may be provided with an opportunity to select a page of the template to design and/or edit. Of course, one skilled in the art of Internet usage or the law will appreciate that this feature may be designed to operate in other fashions.
   60. On the occasion that self-authentication is required by a user or a party related to the user in some fashion, the administrator will take whatever additional measures necessary to establish the self-authentication taking into account the process necessary to insure privacy and that the function of the website meets its functional criteria. This means compliance with court orders, legal proceedings and the Federal Rules of Evidence.
   61. Finally, other embodiments and uses of these inventions will be apparent to those skilled in the art from consideration of the specification and practice of the inventions disclosed herein. All references cited herein, including all U.S. and foreign patents and patent applications, are specifically and entirely hereby incorporated herein by reference. It is intended that the specification and examples be considered exemplary only, with the true scope and spirit of the inventions indicated by the claims. As will be easily understood by those of ordinary skill in the art, variations and modifications of each of the disclosed embodiments can be easily made within the scope of these inventions as defined by the claims.

1. I claim as my invention permanent Internet uploads consisting of: any form of an upload of any item or volume of a document, photograph, video or transmission, including but not limited to a .txt, docx., doc., pdf, jpg. .xls, xlsx, .inf, .htm, .html, .wpd, .bmp, rtf, .lnk, .inf, .eml, .wbk, or otherwise that may be transmitted over the Internet to our website(s) or forum(s) or blog(s). Once uploaded, these forms will not be able to be manipulated or altered. While the upload cannot be altered, it may be suppressed into a private file not available for public viewing for any limited number of reasons such as violation of any law, copyright infringement, direction of the user or discretion of the IDM administrator.

2. I claim as my invention Internet self-authenticated records consisting of: any form of an upload of any item or volume of a document, photograph, video or transmission per the method and process of claim 1, that may be transmitted over the Internet to our website(s) or forum(s) or blog(s). These uploads may be in a public or private file, blog, forum or page of the user. The process that will be followed to complete the self-authentication for federal court compliance is specified by the Federal Rules of Evidence (incorporating revisions that took effect Dec. 1, 2010).

3. I claim as my invention Internet self-authenticated documents consisting of: any form of an upload of any item or volume of a document, photograph, video or transmission per the method and process of claim 1, that may be transmitted over the Internet to our website(s) or forum(s) or blog(s). These uploads may be in a public or private file, blog, forum or page of the user. The process that will be followed to complete the self-authentication for federal court compliance is specified by the Federal Rules of Evidence (incorporating revisions that took effect Dec. 1, 2010).

4. I claim as my invention Internet self-authenticated photographs consisting of: any form of an upload of any item or volume of a document, photograph, video or transmission per the method and process of claim 1, that may be transmitted over the Internet to our website(s) or forum(s) or blog(s). These uploads may be in a public or private file, blog, forum or page of the user. The process that will be followed to complete the self-authentication for federal court compliance is specified by the Federal Rules of Evidence (incorporating revisions that took effect Dec. 1, 2010).

5. I claim as my invention Internet permanent, self-authenticated, chronological records, documents and photographs consisting of: any form of an upload of any item or volume of a document, photograph, video or transmission per the method and process for permanence as provided by claim 1, that may be transmitted over the Internet to our website(s) or forum(s) or blog(s). These uploads may be in a public or private file, blog, forum or page of the user. The process for self-authentication is provided by the method and process per claim 2, claim 3 and/or claim 4. All uploads will be dated at the time received and kept in their received order.

6. I claim as my invention Internet permanent, chronological, self-authenticated, archived records, documents and photographs consisting of: any form of an upload of any item or volume of a document, photograph, video or transmission per the method and process for permanence as provided by claim 1, that may be transmitted over the Internet to our website(s) or forum(s) or blog(s). These uploads may be in a public or private file, blog, forum or page of the user. The process for self-authentication is provided by the method and process per claim 2, claim 3 and/or claim 4. All uploads will be dated at the time received and kept in their received order as provided by claim 5. These uploads will be kept on the website in a method as a place or collection containing records, documents, or other materials of historical interest.

7. I claim as my invention Internet user-driven permanent private or public records, documents and photographs consisting of: any form of an upload of any item or volume of a document, photograph, video or transmission per the method and process for permanence as provided by claim 1, that may be transmitted over the Internet to our website(s) or forum(s) or blog(s). These uploads may be in a public or private file, blog, forum or page of the user. The process for self-authentication is provided by the method and process per claim 2, claim 3 and/or claim 4. All uploads will be dated at the time received and kept in their received order as provided by claim 5. These uploads will be kept on the website in a method as a place or collection containing records, documents, or other materials of historical interest per claim 6.

8. I claim as my invention Internet Universal Personal Permanent Cloud Server consisting of: Cloud Servers, Cloud Computing, Cloud Hosting & Online Storage. Cloud hosting has been broadly defined as an on-demand, pay-as-you-go, high-availability service, as opposed to an order-to-provision, annually-contracted, configure-your-own-backups and buy-or-lease-your-servers kind of a service. This is by an upload of any item or volume of a document, photograph, video or transmission per the method and process for permanence as provided by claim 1, that may be transmitted over the Internet to our website(s) or forum(s) or blog(s). These uploads may be in a public or private file, blog, forum or page of the user per claim 7. The process for self-authentication is provided by the method and process per claim 2, claim 3 and/or claim 4. All uploads will be dated at the time received and kept in their received order as provided by claim 5. These uploads will be kept on the website in a method as a place or collection containing records, documents, or other materials of historical interest per claim 6.

9. I claim as my invention permanent, archived, social networking records, documents and photographs consisting of: a social network service focuses on building and reflecting of social networks or social relations among people, e.g., who share interests and/or activities. This method uses communications, emails, and/or uploads of any item or volume of a document, photograph, video or transmission per the method and process for permanence as provided by claim 1, that may be transmitted over the Internet to our website(s) or forum(s) or blog(s). These uploads may be in a public or private file, blog, forum or page of the user per claim 7. The process for self-authentication is provided by the method and process per claim 2, claim 3 and/or claim 4. All uploads will be dated at the time received and kept in their received order as provided by claim 5. These uploads will be kept on the website in a method as a place or collection containing records, documents, or other materials of historical interest per claim 6.

10. I claim as my invention Internet self-authenticated Legal Forms, Documents and Templates consisting of: User Directed Legal Forms, Legal Documents and Legal Templates as provided by IDM that can be personalized by the user, permanently stored on IDM, and also delivered to the user by mail or email. The user may also upload the executed form pursuant to the processes detailed by each as part of claim 1, claim 2, claim 3, claim 4, claim 5, claim 6, and claim 7.

11. I claim as my invention Internet self-authenticated, archived and permanent records of expert commentary and feedback consisting of: as an upload is being transmitted to IDM, the user doing the upload may email everyone or to part of his contacts file for commentary and/or feedback about the user's upload. The communication to the user may be self-authenticated, archived and permanent pursuant to the processes detailed by each as part of claim 1, claim 2, claim 3, claim 4, claim 5, claim 6, and claim 7.

12. I claim as my invention online Internet chronologically archived, self-authenticated records, documents and photographs for personal or business communications and recordings consisting of: Personal and Business Records Archival with Sales Opportunities using personal email transmissions for sharing and organizing personal files, as a single clearinghouse opportunity with chronological archiving services. The communication from the user may be self-authenticated, archived and permanent pursuant to the processes detailed by each as part of claim 1, claim 2, claim 3, claim 4, claim 5, claim 6, and claim 7.

13. I claim as my invention Internet permanent, self-authenticated records, documents and photographs in forums and/or blogs consisting of: IDM Forums/Blogs with the IDM Forum, an “online” discussion site for blogging, and writing a blog (which is short for web log). IDM's forums provide for a user generated diary or journal. Subjects for blogging include commentary on politics or current events, recipes, or anything of interest to the ‘blogger’. The communication to and from the user may be self-authenticated, archived and permanent pursuant to the processes detailed by each as part of claim 1, claim 2, claim 3, claim 4, claim 5, claim 6, and claim 7.

14. I claim as my invention online Internet self authenticated, permanent photograph management and sharing consisting of: IDM Photography management and sharing application. A user may show off favorite photos and videos to the world, securely and privately show content as well as create photo books, buy cards & stationery, and share photos with family and friends as well as keep a permanent log of these communications. The communication to and from the user may be self-authenticated, archived and permanent pursuant to the processes detailed by each as part of claim 1, claim 2, claim 3, claim 4, claim 5, claim 6, and claim 7.

15. I claim as my invention Internet self-authenticated records, documents and photographs as comprehensive collections by commercial and private collectors consisting of: compendiums of the collections of the articles bought, sold or traded may be kept in a permanent journal. The records, journals and communication to or from the user may be self-authenticated, archived and permanent pursuant to the processes detailed by each as part of claim 1, claim 2, claim 3, claim 4, claim 5, claim 6, and claim 7.
